(19) United States
(12) Patent Application Publication
(10) Pub. No.: US 2004/0051398 A1
(43) Pub. Date: Mar. 18, 2004

(54) Device for rapid short-circuit protection in a power semiconductor

(76) Inventors: Torsten Mohr, Leonberg (DE); Joerg Jehlicka, Ludwigsburg (DE); Ralf Moser, Rutesheim (DE); Thomas Hils, Wurmberg (DE); Ralf Hadeler, Luenedurg (DE)

Correspondence Address: KENYON & KENYON, ONE BROADWAY, NEW YORK, NY, 10004, US

(21) Appl. No.: 10/343,346

(22) PCT Filed: Jul. 18, 2001
(86) PCT No.: PCT/DE01/02704

(30) Foreign Application Priority Data
Jul. 29, 2000 (DE) 100 36 983.9

(51) Int. Cl. H01H 3/26; H01H 3/28; H01H 9/54; H01H 33/59; H01H 47/00; H01H 85/46

(52) U.S. Cl. 307/140

(57) ABSTRACT

A device for rapid short-circuit protection in a power semiconductor is described. It has at least one power semiconductor (10, 38) via which a load current (IL) may be applied to at least one electric load (24). The current detection means (14, 18, 46) provide a measure (VIS) of the load current (IL) applied to the electric load (24). A semiconductor protective circuit (30, 32, 34, 36) triggers the power semiconductor (10, 38) to protective operation in the event of an imminent impairment of the power semiconductor (10, 38). In addition to the semiconductor protective circuit (30, 32, 34, 36), at least one additional electronic component (62, 72, 74) is provided to compare the load current (IL) or a measure (VIS) of the load current with a limiting value (60, VCC), monitoring means (34, 76, 78, 86) being provided to trigger the power semiconductor (10) to protective operation with respect to the electric load (24) in the event the load current or a measure thereof exceeds or drops below the limiting value (60, VCC).

### BACKGROUND INFORMATION

The present invention is directed to a device for rapid short-circuit protection in a power semiconductor according to the preamble of the independent claim. A sense high-side switch having important protective functions integrated into it is described in the article “Sense-Highside-Schalter übernimmt Sicherungsfunktionen [Sense High-Side Switch Assumes Safety Functions],” by A. Blessing, A. Graf, P. Sommer in the journal Components, 5-6/97, pages 32 to 35 (BTS 640S2). An overheat cutoff and a current-limiting function, which are continuously active, are provided. A signal proportional to a load current may be picked up at a sense output of the power semiconductor. This sense voltage is analyzed by an A/D converter of a microcontroller and processed further, e.g., for fusing purposes.

However, in this power semiconductor there is no possibility for altering the internal current-limiting function, i.e., the value of the cutoff current from the outside. Depending on the use of the power semiconductor, maximum peak currents of consumers connected to it may vary greatly. In most cases, the current limit is set very high by the manufacturer of the power electronic unit to ensure protection of the power semiconductor itself. Since a power semiconductor that is accurately adapted for each application with regard to continuous current and/or maximum peak current is not available for each application, it is often necessary to use oversized power semiconductors. This in turn results in, for example, an unnecessarily high current flowing over the plugs, the circuit boards, i.e., the printed conductors, the power semiconductor, the cable and short-circuit sink, e.g., in the case of a short circuit until detection and initiation of countermeasures. In order not to have to dimension components that might be subject to a short circuit for the short-circuit current of the power semiconductor, it is desirable to have a short-circuit shutdown of the power semiconductor, the value of which is designed to be rapidly applicable. The applicable short-circuit shutdown is especially important in conjunction with a dual-voltage vehicle electric system (12 V/42 V) to make it possible to control a short circuit between the two voltage levels.

Such a multivoltage vehicle electric system is described, for example, in German Patent Application 199 448 33, which has been published subsequently. Short-circuit protection means are provided between the two voltage levels of the multivoltage vehicle electric system to largely reduce a short circuit and/or prevent the effects of a short circuit between the two voltages and/or protect or shut down endangered consumers in the event of a short circuit. Analysis of a possible overcurrent is controlled by a program in a microcontroller.

The object of the present invention is to provide a device which will increase the security with respect to short circuits. This is to be accomplished in an inexpensive manner.

This object is achieved through the features of the independent claim.

### ADVANTAGES OF THE INVENTION

The device according to the present invention for rapid short-circuit protection in a power semiconductor includes at least one power semiconductor via which a load current may be applied to at least one electric load. Current detection means are provided, providing a measure of the load current applied to the electric load. A semiconductor protective circuit triggers the power semiconductor into protective operation in the event of an imminent impairment of the power semiconductor. According to the present invention, in addition to the semiconductor protective circuit, at least one additional electric component is provided to compare the load current or a measure of the load current with a limiting value, where monitoring means trigger the power semiconductor into protective operation with regard to the electric load when the monitored value exceeds the maximum limiting value or drops below the minimum limiting value. The additional load current monitoring is implemented according to the present invention by a hardware circuit. In comparison with a software-based analysis, there are advantages with regard to the speed with which a possible overload is detected. Therefore, countermeasures may be initiated rapidly to reliably protect the electric load. The value of the short-circuit shutdown of the power semiconductor is preferably adjustable by the user. The user is thus given an opportunity to use the power semiconductor for triggering any loads by selecting a suitable dimension for the limiting value.

In an expedient refinement, a locking circuit is provided to suppress activation of the power semiconductor when the monitored value drops below the limiting value in the meantime. The locking circuit increases protection against permanent damage to the power semiconductor and/or the electric load because the on and off operations in particular constitute a special risk for the power semiconductor and the electric load. It is possible to inquire as to the status of the lock for further processing. The power semiconductor is enabled to resume normal operation only by a specific unlocking signal. This targeted control increases the ability of a user to influence the protective function of the power semiconductor.

Additional expedient refinements are derived from additional dependent claims and from the description.

### DRAWING

Exemplary embodiments of the present invention are illustrated in the drawing and explained in greater detail in the following description.

FIGS. 1 and 2 show typical embodiments of the power semiconductor;

FIG. 3 shows an additional protective function implemented in the power semiconductor;

FIG. 4 shows a protective function implemented outside the semiconductor; and

FIG. 5 shows a typical dual-voltage vehicle electric system in which the power semiconductors are preferably used.

### DESCRIPTION OF THE EXEMPLARY EMBODIMENTS

An integrated power semiconductor 10 has at least one load output 12 by which an electric load 24 may be supplied with a load current IL, which flows toward ground 26. A switching means 20 is provided for activating power semiconductor 10; when the switching means is closed, a control input 16 of power semiconductor 10 is at a logical reference potential 22. Power semiconductor 10 has a current balancing output 14 at which a current proportional to load current IL flows across a shunt 18 to logical reference potential 22. Voltage drop VIS induced across shunt 18 is analyzed.

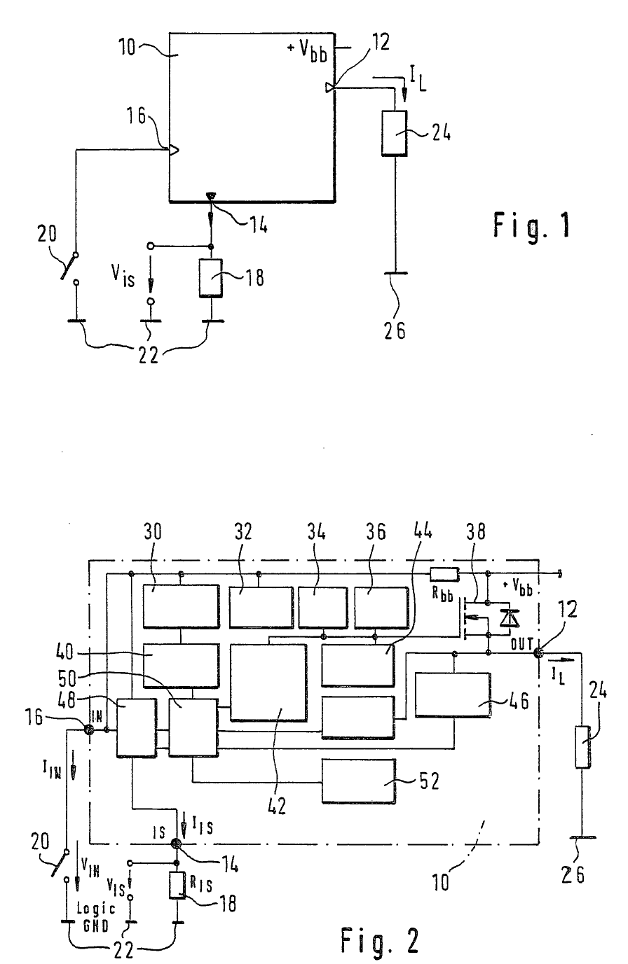

In the exemplary embodiment according to FIG. 2, the individual components of power semiconductor 10 are shown in greater detail. Various protective and analyzing functions are provided, such as a voltage source 30, a surge suppressor 32, a current-limiting device 34, a gate protection 36, the actual power switch 38, a voltage sensor 40, a charge pump 42, a protective circuit for inductive loads 44, a current detection unit 46, an electrostatic discharge protection 48, a logic circuit 50 and a temperature sensor 52. Otherwise, the external components correspond to those in FIG. 1.

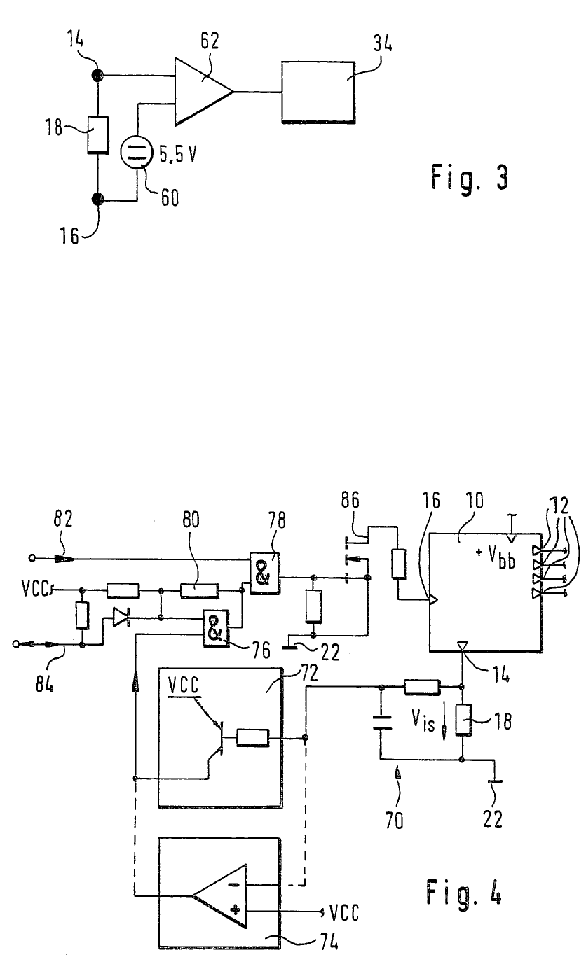

The exemplary embodiment according to FIG. 3 is used for an internal protective circuit acting directly on current-limiting device 34 of power semiconductor 10. To do so, current balancing output 14 is connected to control input 16 across shunt 18 for the case when switching means 20 is closed and thus power semiconductor 10 has been activated. Voltage drop VIS across shunt 18 is compared with a reference voltage 60 by a comparator 62. The output signal of comparator 62 is sent to current-limiting device 34.

In the exemplary embodiment according to FIG. 4, voltage drop VIS across shunt 18 is smoothed by a filter 70 composed of an RC element, for example. The smoothed output voltage is sent to a transistor stage 72 or as an alternative to an inverting input of a comparator 74. If smoothed voltage VIS exceeds a certain limiting value VCC, then the output signal of transistor stage 72 as well as that of comparator stage 74 become logical 0. These output signals are sent to a first AND gate 76 whose output signal is sent as an input signal to a second AND gate 78. The output signal of first AND gate 76 goes to the second input of first AND gate 76 via a seal-in resistor 80. An unlocking signal 84 may also go via a diode to the second input of first AND gate 76. In addition, the condition of the locking circuit and/or the seal-in circuit may also be queried via two resistors via the pin through which unlocking signal 84 of the locking circuit may also be sent. Regular triggering 82 of power semiconductor 10 (and thus of load 24) is sent to the second input of second AND gate 78. When activation is requested in normal operation, switching means 86 is triggered, so that control input 16 of power semiconductor 10 is at a logical reference potential 22 so that load current IL is applied to electric load 24 (not shown in FIG. 4).

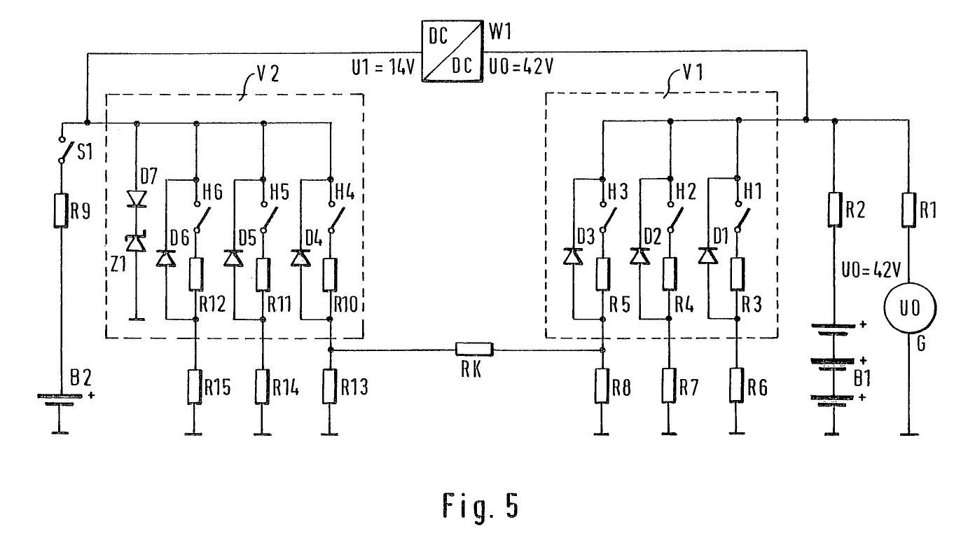

FIG. 5 illustrates the essential components of a dual-voltage vehicle electric system of a motor vehicle. Specifically, generator G, e.g., a claw-field three-phase generator driven by the vehicle engine is shown. Generator G supplies an output voltage U0 of 42 V, for example, which is used directly to charge battery B1 with a rated voltage of 36 V. The line resistance between generator G and battery B1 is symbolized by resistors R1 and R2. The consumers, which are to be supplied with voltage U0, are connected to generator G by a signal/power distributor V1. In particular, three consumers R6, R7 and R8 are shown here as examples of electric load 24, connectable to generator G via power semiconductors H1, H2 and H3. These power semiconductors H1, H2 and H3 have inverse diodes D1, D2 and D3 and internal resistors R3, R4 and R5 determined by the design.

A second battery B2 is charged by generator G via a d.c.-d.c. converter W1. The d.c.-d.c. converter W1 converts voltage U0=42 V into a voltage U1=14 V which is suitable for charging battery B2 having a rated voltage of 12 V. Voltage U1 is supplied from voltage converter W1 to battery B2 via switch S1 and the line having line resistance R9. Resistance R9 also includes the internal resistance of battery B2.

Battery B2 is used to supply consumers which require a lower voltage, e.g., 12 V or 14 V. The connection is accomplished via signal power distributor V2. These consumers are labeled as R13, R14 and R15, and they may be switched on via power semiconductors H4, H5 and H6 having inverse diodes D4, D5 and D6, respectively. The line resistances between consumers R13, R14 and R15 are labeled as R10, R11 and R12.

The consumers that are to be supplied with 12 V or 14 V power via SLV2 also include, if so decided, a Zener diode Z1 and another diode D7, which together form a surge suppressor. Zener diode Z1 and additional diode D7 are mentioned only as examples of possible voltage-limiting means. It is also possible to use other limiter circuits.

The consumers for one voltage level or the other are selected depending on the voltage requirements for optimum operation of these consumers. For example, the starter may be connected to either the 12 V battery or the 36 V battery. When using power semiconductors on the 14 V side, the switch having the short-circuited 14 V load becomes conducting through the inverse diode of the respective power semiconductor which is always present and thus connects all the 14 V consumers to 42 V, so that the consumers which are not designed for this voltage level are endangered. FIG. 5 shows such a short circuit. A resistor RK which is between resistors R8 and R13 on the voltage side represents a short circuit, the effects of which are to be ameliorated according to the present invention. The following discussion will explain how the effects of a short circuit, symbolized by resistance R16, may be limited.

In the exemplary embodiments according to FIGS. 1 and 2, shunt 18 converts output current IS of current balancing output 14 into a voltage signal VIS which is proportional to load current IL, usually being directly proportional. Shunt 18 is dimensioned so that the current range of interest for the given application, between a value of zero and the peak current, which is converted to a conventional voltage range for an A/D converter, e.g., 0 to 5 V. As soon as voltage drop VIS across shunt 18 is greater than 5 V, this is outside the desired current range. This usually signals a fault case such as a short circuit in the overall system. In this case, power semiconductor 10 should be triggered into protective operation. Protective operation is understood to be, for example, operation with a current-limiting function or complete shutdown of power semiconductor 10.

As a rule, power semiconductor 10 does not have any possibility of picking up logical reference potential 22 to detect the voltage drop across shunt 18 based on this logical reference potential 22. To overcome this problem, it is proposed that voltage drop VIS across shunt 18 be measured relative to the potential picked up at control input 16. In the case of triggering of power semiconductor 10, switching means 20 is closed and thus control input 16 is at logical reference potential 22. Control input 16 is suitable for this application, however, because monitoring is of interest only in the activated state of power semiconductor 10.

According to FIG. 3, comparator 62 as an electronic component compares voltage drop VIS across shunt 18 with reference voltage 60. For the reasons explained above, this voltage is 5.5 V, for example, to reliably detect when the working range of load current IL is exceeded. If voltage drop VIS across shunt 18 exceeds reference voltage 60, the output signal of comparator 62 activates current-limiting function 34 already integrated into power semiconductor 10. The current-limiting circuit either causes a direct shutdown of power semiconductor 10, 38 or it regulates the voltage drop across shunt 18 to a maximum of 5.5 V. This would result in limiting load current IL to a value proportional to reference voltage 60. The user may adapt reference voltage 60 to the particular application case, i.e., to electric load 24 to be triggered as desired. This supplementary circuit is relatively small in comparison with the circuit of power semiconductor 10, which is already present, and thus it increases the additional cost only slightly. However, the functionality of power semiconductor 10 is greatly increased without having to perform intervention measures in the semiconductor circuit itself. Thus, the user's previous wiring may remain the same.

In the exemplary embodiment according to FIG. 4, external monitoring means are provided, simultaneously producing a rapid shutdown of power semiconductor 10. For implementation of the protective function, contrary to the exemplary embodiment illustrated in FIG. 3, this embodiment no longer relies on internal current-limiting function 34 of power semiconductor 10. Instead, power semiconductor 10 is shut down via control input 16, as explained below. In normal operation, load current IL is within the allowed range. Therefore, the output signal of first AND gate 76 has the logic 1 state, so that triggering 82 reaches the control input of switching means 86 unhindered. If triggering 82 signals a requested activation of load 24, then switching means 86 sets control input 16 at logical reference potential 22. Therefore, load current IL is applied to load 24. The signal which is proportional to load current IL is available at current balancing output 14. Voltage drop VIS across shunt 18 is smoothed by (optional) RC element 70. The output signal smoothed in this way is sent either to transistor stage 72 or to comparator stage 74 to perform monitoring whether a definable limiting value has been exceeded. In the exemplary embodiment, the limiting value is selected as the VCC signal, so it is approx. 5 V. If smoothed voltage drop VIS across shunt 18 exceeds reference voltage VCC of 5 V, then either transistor stage 72 or comparator stage 74 will output an output signal of logical zero. This output signal of logical zero is sent to first AND gate 76, whose output signal also assumes the value logical zero. Since the output signal of first AND gate 76 is also used as the input signal of second AND gate 78, the output signal of second AND gate 78 changes its logical state to logical zero. Thus switching means 86 is no longer triggered so that control input 16 is no longer at logical reference potential 22. Therefore, power semiconductor 10 is switched off. Current flow IL through load 24 is suppressed. A locking circuit is provided to suppress immediate renewed activation of power semiconductor 10. To do so, the output signal of first AND gate 76 goes across seal-in resistor 80 to the second input of first AND gate 76. Thus, the logical zero signal is also at the second input of AND gate 76 once the monitoring function is activated, so the output signals of the two AND gates 76, 78 remain constantly at logical zero. The condition of the locking circuit may be queried by signal 84. This may be used for additional analysis purposes. A locking signal having the logical zero state signals that the protective function has been activated. To be able to return power semiconductor 10 to operation, the user must apply a signal 84 having the logical 1 state to the second input of first AND gate 76. In the normal case, load current IL will not have exceeded limiting value VCC, so first AND gate 76 is acted upon by two logical 1 signals, so that its output also assumes the logical 1 value. Triggering signal 82 is thus switched through to the output of second AND gate 78 to allow activation of switching means 86 as desired with the corresponding action upon control input 16. Semiconductor 10 may thus be triggered again, so that load current IL may flow through electric load 24.

Power semiconductors 10 may be used as power semiconductors H1-H6 in the manner already described in the exemplary embodiment according to FIG. 5. In the event of a short circuit between different voltage levels U1 and U0 of the multivoltage network in particular, the electronic components contribute toward early detection of an unacceptable load current IL and initiation of countermeasures.

What is claimed is:

1. A device for rapid short-circuit protection in a power semiconductor, comprising
at least one power semiconductor (10, 38) via which a load current (IL) may be applied to at least one electric load (24),
current detection means (46, 14, 18) which provide a measure (VIS) of the load current (IL) applied to the electric load (24),
a semiconductor protective circuit (30, 32, 34, 36) which triggers the power semiconductor (10, 38) in a protective operation in the case of an imminent impairment of the power semiconductor (10, 38),
wherein, in addition to the semiconductor protective circuit (30, 32, 34, 36), at least one additional electronic component (62, 72, 74) is provided which compares the load current (IL) or a measure (VIS) of the load current to a limiting value (60, VCC), monitoring means (34, 76, 78, 86) being provided, which trigger the power semiconductor (10, 38) into protective operation with respect to the electric load (24), in the event the load current or a measure thereof exceeds or drops below the limiting value (60, VCC).

2. The device as recited in claim 1,
wherein a comparator (62, 74) and/or a transistor stage (72) are provided as the electronic component.

3. The device as recited in one of the preceding claims,
wherein a locking circuit is provided to suppress a renewed initiation of protective operation with respect to the electric load (24).

4. The device as recited in one of the preceding claims,
wherein the semiconductor circuit (30, 32, 34, 36) is activated when the load current or a measure thereof exceeds or drops below the limiting value (60, VCC) in a protective operation with respect to the electric load (24).

5. The device as recited in one of the preceding claims,
wherein the control input (16) of the power semiconductor (10, 38) is used for current detection.

6. The device as recited in one of the preceding claims,
wherein the state of the locking circuit is detected.

7. The device as recited in one of the preceding claims,
wherein no load current or a maximum allowed load current (IL) is applied to the electric load (24) in a protective operation with respect to the electric load (24).

8. The device as recited in one of the preceding claims,
characterized by its being used in a dual-voltage electrical system of a motor vehicle.
